(19) United States
(12) Patent Application Publication
(10) Pub. No.: US 2005/0276252 A1
(43) Pub. Date: Dec. 15, 2005

(54) Medium access control for wireless networks

(76) Inventors: Robert L. Sizeland, Calgary (CA); Abraham O. Fapojuwo, Calgary (CA); Robert J. Davies, Calgary (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/149,459

(22) Filed: Jun. 8, 2005

Related U.S. Application Data
(60) Provisional application No. 60/577,925, filed on Jun. 9, 2004.

(51) Int. Cl. H04Q 7/24

(52) U.S. Cl. 370/338

(57) ABSTRACT

A system for communicating data comprising a client station adapted to connect to a server station by a wireless contention link for exchanging data between the client station and the server station, where the data exchanged has loose quality of service requirements. The client station is also adapted to connect to the server station by at least one wireless non-contenition link for transmitting data from the server station to the client station where the data transmitted has stringent quality of service requirements.

### BACKGROUND OF THE INVENTION

As the services home networks provide evolve from printer and file sharing to intelligent home management centres and entertainment sources, the underlying structure of these networks must also evolve. The hardware and protocols must be designed with the environment and traffic type seen in a home in mind. Simple control commands to many already wired fixtures will require one type of physical layer (PHY) and low level protocol, while large, time sensitive multimedia streams to a few fixed and/or mobile devices will require another physical layer and set of protocols.

While some networked services in the home can be provided over existing wiring (power and phone lines), the bandwidth and delay required for high quality digital video and sound requires either new wires or a wireless solution. Since new wiring is expensive and inconvenient, in many cases a wireless solution is the most cost-effective. Not only will a wireless home network for media need to cope with the wireless channel, it must provide Quality of Service (QoS) in terms of latency and bandwidth guarantees to the traffic it carries.

Home Networks

IEEE 802.11 networks have become popular and inexpensive, so they are a likely contender for a wireless home network and are therefore the focus of discussion in this section. At first glance, protocols like 802.11a/g, boasting data rates of up to 54 Mbit/s look like they would be suitable for streaming high bandwidth content around the home. This is not the case, however, as these protocols evolved as a wireless Ethernet replacement. The medium access scheme used is Carrier Sense Multiple Access with Collision Avoidance, where a station requiring the wireless medium waits a random amount of time before transmitting, depending on how heavily the network is loaded. This style of distributed medium access control where each traffic flow is treated equally does not work well with a mix of traffic that has different QoS requirements.

Research has been done that considers the delivery of multimedia over 802.11 networks, such as P. Berthou, T. Gayraud, O. Alphand, C. Prudhommeaux, and M. Diaz, “A multimedia architecture for 802.11b networks,” in Proceedings of Wireless Communications and Networking, March 2003, pp. 1742-1747 and others, but they often propose a change in the standard or vendor specific algorithm. 802.11 networks are best used with delay tolerant applications that operate on the TCP/IP stack (P. Fowler, “5 GHz goes the distance for home networking,” Microwave Magazine, IEEE, vol. 3, no. 3, pp. 49-55, September 2002). Though some traffic in the home fits this description, much of it will be high quality delay-sensitive multimedia.

The IEEE has addressed the issue of time sensitive traffic over 802.11 networks with a task group on Quality of Service, 802.11e. This draft Quality of Service proposal groups traffic into access classes with different priorities and gives each class different probabilities of accessing the channel (S. Mangold, S. Choi, P. May, O. Klein, G. Hiertz, and L. Stibor, “IEEE 802.11e wireless LAN for quality of service,” in Proceedings of the European Wireless, 2002, pp. 32-39 [Cited as Mangold]). While this method does provide some quality of service to time sensitive traffic, there are no guarantees made with respect to bandwidth or latency. In addition, it is constrained in that it must be compatible with legacy equipment.

### SUMMARY OF THE INVENTION

There is therefore provided, according to an aspect of the invention, a system for transmitting data. A server station is adapted for receiving a request to transmit data to a client station. The server station transmits the requested data from the server station to the client station on a wireless non-contention link. Control data is exchanged between the client station and the server station on a separate wireless contention link to control the transmission of the requested data on the wireless non-contention link. The request to transmit data may be initiated by the client station and transmitted over the wireless contention link. The requested data may be transmitted on a 5 GHz non-contention link, and the control data may be transmitted on a 2.4 GHz contention link. The non-contention link may comprise a plurality of channels, and the method may further comprise the steps of transmitting data on a channel on the non-contention link, detecting the quality of service of the channel, and transmitting data on a different channel on the non-contention link when the quality of service of the original channel drops below a threshold.

According to a further aspect of the invention, the server station receives a plurality of requests for data, the quality of service required for each request and the available resources on the non-contention link are determined, the requested data is transmitted on the non-contention link at the required quality of service; and the requests for data that exceed the available resources are cancelled.

According to further aspect of the invention, the server station copies the requested data as data packets to a transmission queue, the data packets in the transmission queue are transmitted from the server station to the client station, the transmitted data packets are copied by the server station into an acknowledgement queue, the status of received data packets are transmitted from the client station to the server station, and the server station copies unreceived data packets, such as incomplete data packets, from the acknowledgement queue to the transmission queue. The method may also include the steps of assigning the data packets a sequence number, the client station copying out of sequence data packets to an out of sequence data queue, and the client station copying sequence numbers that are intermediate received sequence data packets to an unreceived data packet queue. Transmitting the status of received data packets may comprise transmitting the sequence numbers in the unreceived data packet queue.

According to a further aspect of the invention there is provided a system for employing the above method.

According to a further aspect of the invention, there is provided an enhanced node for a wireless area network (WLAN). The node comprises: an entry point adapted to intercept data from the WLAN to the node and data from the node to the WLAN, a demultiplexer adapted to direct the data from the entry point to an application at the node or to a classifier, and the classifier adapted to classify the data to be transmitted on the WLAN as data to be transmitted on1 a wireless contention link or as data to be transmitted on a wireless non-contention link.

According to a further aspect of the invention, there is provided a MAC sublayer comprising a server station sublayer and a client station sublayer. The server station sublayer comprises a transmission queue, an acknowledgement queue, and a transmitter, the transmitter adapted to transmit data packets in the transmission queue on a wireless non-contention link and copy the data to the acknowledgement queue. The client station sublayer comprises an out-of sequence packet queue for storing data packets that are received out of sequence, an unreceived sequence number list for storing the sequence number of unreceived data packets, and a timer for transmitting the status of received data packets to the server station sublayer on a wireless contention link. The transmitter may also comprise a scheduler adapted to determine the strength of a current transmission channel within the non-contention transmission link and to switch to a stronger transmission channels if the strength of the current transmission channel drops below a threshold.

Further aspects of the invention will be apparent from the claims and description of the preferred embodiments, which are incorporated by reference.

### BRIEF DESCRIPTION OF THE DRAWINGS

There will now be given a description of the drawings, by way of illustration only and not with the intent of limiting the invention, where like reference characters denote like elements, and where:

FIG. 1 depicts the structure of the Medium Access Control (MAC) scheme of the present invention in the server station;

FIG. 2 depicts the structure of the MAC scheme in the client station;

FIG. 3 depicts a network implementing the MAC scheme;

FIG. 4 depicts the structure of an enhanced network node;

FIG. 5 is an example mapping of flows;

FIG. 6 is a graph representing end-to-end packet delay for multiple videos; and

FIG. 7 is a graph contrasting the throughput efficiency of the MAC scheme of the present invention with a prior art MAC scheme.

### DETAILED DESCRIPTION OF PREFERRED EMBODIMENTS

In the claims, the word “comprising” is used in its inclusive sense and does not exclude other elements being present. The indefinite article “a” before a claim feature does not exclude more than one of the feature being present.

There is described here a system with a Medium Access Control (MAC) sublayer, designed with quality of service (QoS) for multimedia streams over a high bandwidth wireless link. The system offers higher throughput, lower delays and better quality of service guarantees to time sensitive traffic than provided by prior art. While the scheme may be applicable to many areas, the preferred embodiment incorporates the system into a centralized, wireless local area network (WLAN), such as a home network. Also presented is how the MAC sublayer and its corresponding physical layer would integrate into a home network.

With regards to communicating high bandwidth multimedia in the home, the situation is less likely to resemble a networked office and more likely to consist of a home gateway, or computer, with access to several sources of media, namely video discs and a streaming source from a high bandwidth connection from outside the home. Therefore, a centralized networking protocol operating out of the home gateway is appropriate. A centralized approach gives up some of the flexibility of distributed protocols such as IEEE 802.11, but buys some key features required to distribute multimedia in a small network. First, QoS is much easier to manage out of a central location. Not only can packets be scheduled in a controlled way, but deterministic bounds can be set on parameters such as latency, jitter and bandwidth. Next, admission control can be applied to keep existing streams safeguarded from other traffic. Finally, the management of nodes in the network is simplified.

A wireless media protocol should address the problem of the highly asymmetric nature of the bit rate of high quality media traffic. Depending on the size and resolution of the video, the downlink stream can have a data rate of as much as 20 Mbit/s that requires tight delay and jitter control. The uplink, on the other hand, might only be a few kbit/s of control information and acknowledgment packets that may or may not require QoS. With this in mind, the protocol of the system uses a separate, downlink only channel for the media content, while acknowledgment and control information use an existing shared channel. With the knowledge that the shared channel does not provide quality of service, redundancy is built into the control and acknowledgment packets. This is feasible only with the control channel, as opposed to the media channel, since the data rate is relatively low.

At the expense of another physical channel, this scheme provides many advantages. First, the downlink can be made contention-free, as requests for resources or management information can be made on the control channel. Next, the new media channel does not have to conform to an existing standard intended for another purpose—it can be custom designed to meet the needs of media traffic. Finally, a separate channel for multimedia allows easier growth to higher bit rates. By dedicating less of the time in the channel to management tasks such as protocol headers and acknowledgment packets, throughput will scale more linearly with channel data rate.

The MAC layer of the present system is designed for the challenges of delivering multimedia over a wireless channel is designed to group incoming packets into logical traffic flows, monitor the timing characteristics of packets delivered from each flow, schedule packets such that they meet their QoS requirements, and have a robust acknowledgment/retransmission scheme.

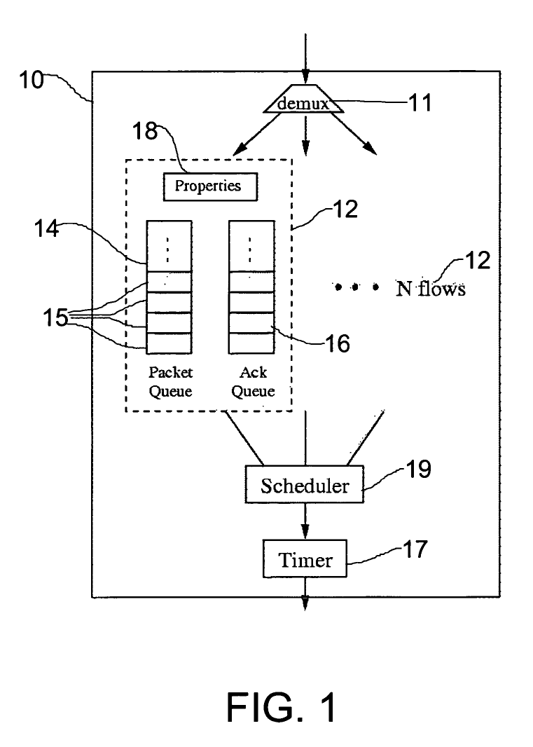

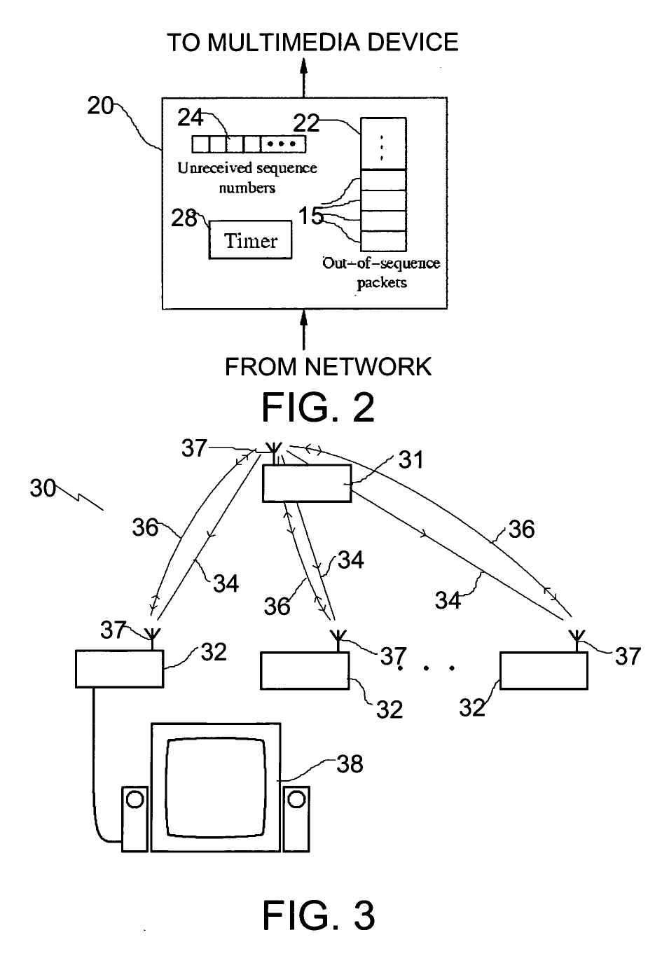

The system satisfies the above demands by assigning each flow a separate QoS queue and monitoring the status of each queue. The number of QoS queues depends on the QoS classes such as time-critical, throughput-dependent, best effort, etc. Since the uplink and downlink are so asymmetrical, the functions of the server, or home gateway, are different than those for a station receiving the media. The basic structure of the MAC at the gateway station 10 and receiver station 20 are shown in FIGS. 1 and 2. In FIG. 1, N flows are shown in the gateway 10. Each flow has a set of properties associated with it, including maximum bandwidth and latency, which the scheduler block 19 is aware of.

Referring to FIG. 3, the system is designed to communicate data on a network 30 between a server station 31, also referred to as a gateway node, and client stations 32, also referred to as receiver nodes. Two links are present between the gateway 31 and each receiver 32: a non-contention link 34 for transmitting data required above a specified quality of service, such as multimedia data, and a contention link 36 for transmitting data not required above a specified quality of service, such as control data. The non-contention link is used to transmit data from the gateway to the receiver. Transmitters 37 are used, and may include a 2.4 GHz transceiver and a 4.8 GHz transceiver. The receiver 32 may be connected, for example, to a multimedia entertainment system 38.

Gateway

The gateway MAC 10 in FIG. 1 includes a flow demultiplexer 11 that is responsible for sorting packets into separate flows. There are N flow objects 12, each containing an outgoing packet queue 14, an acknowledgement queue 16 (or “ack queue”), and a properties block 18. The packet queue 14 holds packets 15 to be transmitted, sorted in order of their arrival time to the MAC. When a packet 15 is transmitted, it is copied to the ack queue 16, which holds packets 15 that have not yet been acknowledged. When an acknowledgment arrives for a packet 15 in the ack queue 16, the packet 15 is discarded. If a negative acknowledgment arrives for a packet 15 in the ack queue 16, the packet 15 is re-inserted in the Outgoing packet queue 14. If neither a positive nor negative acknowledgment is received for a packet 15 in the ack queue 16 after a specified time, it is retransmitted. A timer block 17 is used to keep track of how long packets have been transmitted and not yet acknowledged. If the timer expires without a packet being acknowledged, the packet is then retransmitted. There is also a scheduler 19 used to determine which flow will transmit the next packet 15. More detail on the scheduler 19 is given below.

Receiver

The receiver 20 design shown in FIG. 2 is much simpler. If there are no packet errors, packets 15 are simply passed up the network protocol stack (not shown). The receiver block 20 includes an out-of-sequence packet queue 22 and an unreceived sequence number list 24. When an out-of-order packet 15 is received, it is stored in the out-of-sequence packet queue 22. As each packet 15 has been assigned a monotonically increasing sequence number, missing sequence numbers are added to the unreceived sequence number list 24. This list 24 holds the sequence numbers of packets 15 which have been lost due to the wireless channel. A timer 28 keeps track of the time that has elapsed since the last acknowledgment packet was sent. After a specified number of sequence numbers or specified amount of time, an acknowledgment packet is sent to the gateway MAC 10 via the contention link 34 shown in FIG. 3. If there is still a missing sequence number just before the packet delivery deadline, the packets 15 will be passed up the stack without the missing packet.

Scheduler

The purpose of building a separate channel for multimedia traffic is to provide convenience and scalability to users while preserving the quality of the best wired solution. Since the wireless channel is time-varying and unpredictable, the admission control policy used in a QoS aware high-end entertainment system should be very conservative (the call admission control policy is described below). In the case of unacceptable interference or fading, which is detected by higher than average packet loss, the dynamic channel assignment controller can detect the state of other channels in the band of operation and instruct the receiving stations to change to a better channel. Both dynamic channel assignment and admission control policy take many demands off the scheduling algorithm, so a relatively simple scheduler is used. One possible scheduler is one which randomly and fairly selects a flow n ε [0 . . . N−1], as follows. If x is a random variable uniformly distributed between 0 and 1, and flow i has a maximum bandwidth of BWᵢ, then flow n is selected if

$${\sum }_{i = 0}^{n - 1} \frac{{BW}_{i}}{{\sum }_{j = 0}^{N - 1} {BW}_{j}} < x < {\sum }_{i = 0}^{n} \frac{{BW}_{i}}{{\sum }_{j = 0}^{N - 1} {BW}_{j}}$$

and the packet has not exceeded the maximum allowed latency. In that case, the packet is dropped, as further attempts to transmit it would unnecessarily occupy channel time. To help illustrate how this algorithm works, an example is given.

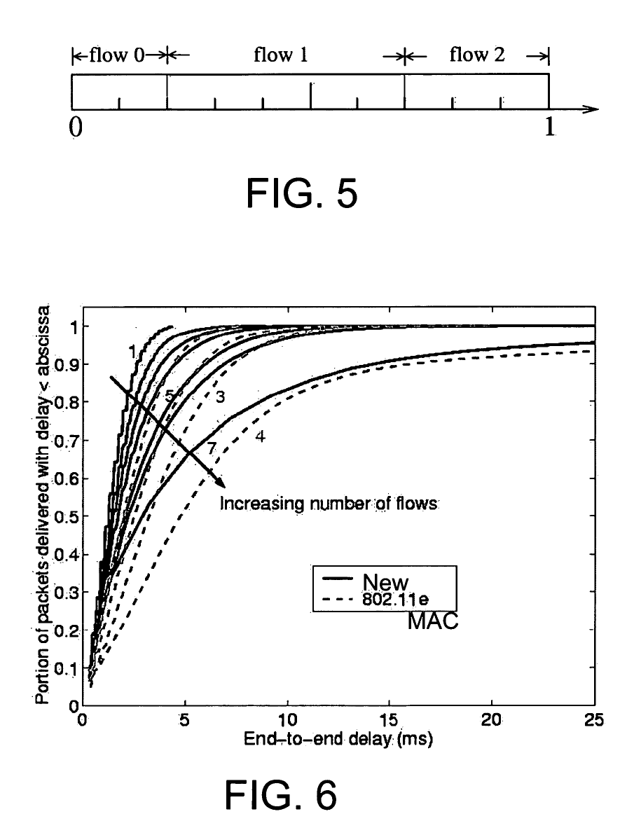

If three flows are registered with the scheduler, flow zero having a bandwidth of 2 Mbit/s, flow one a bandwidth of 5 Mbit/s and flow two a bandwidth of 3 Mbit/s, the flows are essentially mapped to a scale between 0 and 1 in terms of variable x, as shown in FIG. 5. Then, according to the equation presented above:

$$if \{ \begin{matrix}0 < x \leq 0.2 & flow 0 is selected \\ 0.2 < x \leq 0.7 & flow 1 is selected \\ 0.7 < x \leq 1.0 & flow 2 is selected\end{matrix}$$

Protocols that are not multimedia-aware would continue trying to transmit a packet that would ultimately be dropped at the receiver. Although the scheduler can impact how a protocol performs, simulation results have shown that even this simplistic scheduler gives favorable results.

Call Admission Control Policy

The protocol of the MAC sublayer has capability to support calls with different quality of service requirements including high quality video traffic, voice traffic, audio traffic and data traffic. To ensure that the QoS requirements of admitted calls are achieved and maintained, the call admission controller admits calls according to a policy that relies on requested QoS, resource availability at the instant a request is made, and the assurance that the admission of a new call will not degrade the QoS of already admitted calls still in progress.

Dynamic Bandwidth Channel Assignment Controller

The dynamic channel assignment controller constantly monitors the quality (e.g., received signal strength (RSSI), loss rate) of all channels in the operating band and creates a ranked list of the available channels according to their quality level. When the quality level of the active channel used for transmitting to the receiving station falls below an acceptable threshold, the dynamic bandwidth channel assignment controller selects the best candidate ranked channel (i.e., channel at the top of the ranked list) and then instructs the receiving station to switch to the new channel. In this way, QoS is maintained and preserved.

Acknowledgment Scheme

The acknowledgment scheme used must be delay tolerant and reliable, as it is being sent not over a controlled, contention free channel, but over the contention based network which may or may not be loaded with other traffic. A bit vector approach which provides redundancy, similar to that described in H.-S. W. So, Y. Xia, and J. Walrand, “A robust acknowledgement scheme for unreliable flows,” in Proceedings of the IEEE Infocom 2002. vol. 3, New York, N.Y., June 2002, pp. 1500-1509, incorporated herein by reference, may be used. For each flow, a monotonically increasing sequence number i is generated and added to the MAC header of data packet Dᵢ. When the receiver successfully demodulates a packet with sequence number M larger than the last acknowledged packet or an acknowledgment timer of T seconds expires, an acknowledgment packet is generated and sent. The packet contains the sequence number i, implying a positive acknowledgment of packet Dᵢ and a bit vector representing the positive or negative acknowledgment of the last A packets, D_{i-A} . . . Dᵢ₋₁. The vector is generated by setting bit i-1 . . . i-A to 1 for a positive acknowledgment and 0 for a negative acknowledgment. Values for these parameters which give good results are M=15, T=60 ms, A=128.

Node Architecture

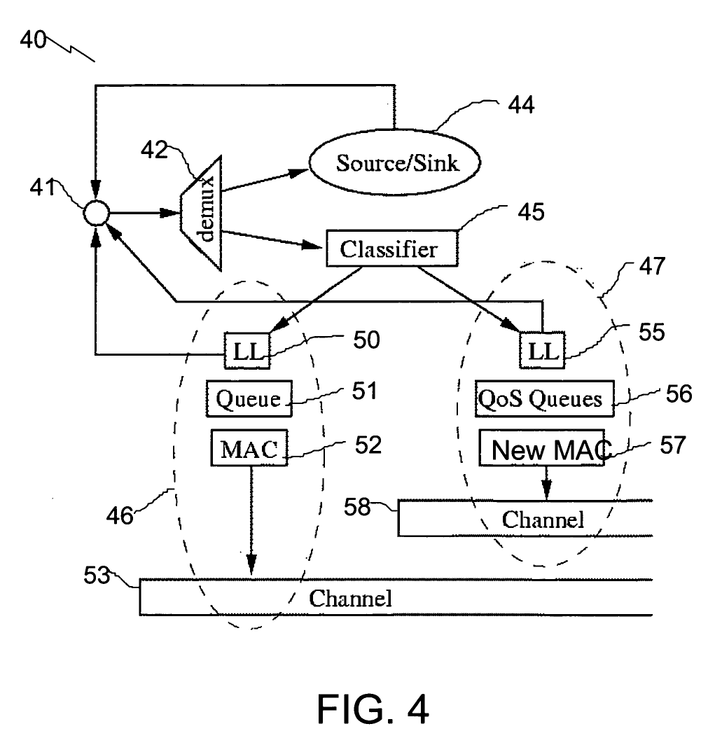

An example node architecture will now be given that implements the present system. Each node 40 in the network architecture is set up as in FIG. 4, called enhanced nodes. The node 40 works as follows: all packets to or from the node 40 are directed to the entry point 41. An address demultiplexer 42 directs the packets either to the peer of an application such as source/sink block 44 that generated them or to the network 30 if the destination warrants. The source/sink block 44 is responsible for generating the media and non-media traffic and is complete from the application to IP layer. The classifier block 45 filters traffic directed to the network 30 to either the contention-based control network 46 or the non-contention (multimedia) network 47.

OSI Layers 1 and 2 of the contention half 46 of the node 40 are built with the 802.11b standard. They include a Link Layer (LL) block 50, single First In First Out (FIFO) queue 51 and IEEE 802.11 compliant MAC layer 52. The physical layer is a 2.4 GHz wireless channel 53 with an 11 Mbit/s maximum data rate. Not only are these network interfaces readily available and cheap, this would allow any enhanced node to communicate with legacy equipment as well as handle the light uplink traffic generated by the media streams.

OSI Layers 1 and 2 of the non-contention downlink half 47 of the node 40 are built with a Link Layer 55, QoS Queues 56 for media traffic streams and the MAC sublayer 57 developed by the inventors specifically for multimedia traffic requiring QoS, and an 802.11a physical layer 58. The 802.11a physical layer was chosen because it is designed for the indoor channel and has sufficient data rate for high quality multimedia applications, but any wireless physical layer fitting this description could be used. Note that this means that two transmitters, one at 2.4 GHz and the other at 5 GHz, will be required at the media source.

Performance

The present system and the 802.11e protocol as described in Mangold were simulated in an event driven Simulator and compared when delivering DVD quality video streams. FIG. 6 shows the end-to-end delivery delay of several streams of high quality video over a 54 Mbps wireless link. It can be seen from the figure that not only does the invented protocol, represented by the solid lines, deliver more video streams than the 802.11e protocol, represented by the dashed lines (7 compared to 4), but the delays are lower.

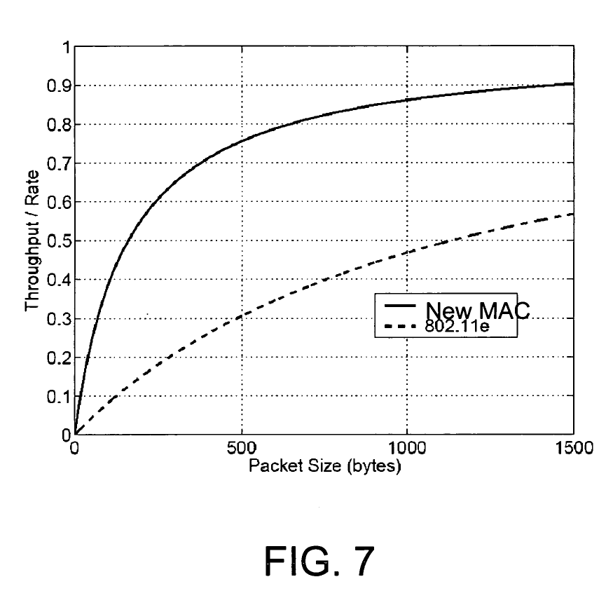

Another advantage of the system is lower overhead due to the fact that there is no contention to use the channel and there is no requirement to be backward compatible with legacy 802.11 networks. The result is higher throughput for a given physical layer data rate. A comparison between the 802.11 protocol with one user and the present system at a physical layer data rate of 54 Mbps is shown in FIG. 7, where the present system is represented by the solid line, and the 802.11 protocol is represented by the dashed line. Efficiency is dependent on packet size, as the amount of overhead is generally fixed. The present system offers better efficiency, especially at lower packet sizes.

### EXAMPLE

The intended use of radios employing this protocol is high end home entertainment equipment such as high definition televisions, surround sound systems and high end stereos. Either the technology would be included in an embedded processing system within the equipment or it would be part of a network interface card that would plug into a standard bus format such as a Personal Computer Memory Card International Association (PCMCIA) slot in the enabled entertainment equipment.

An example of a use of this technology is a video delivery service in a home. The display device would be equipped with the MAC sublayer architecture described above, as is a home gateway which is connected to a high speed connection to a service provider. The gateway would be located elsewhere in the home. Customers would interact with the service provider over the Internet via the 802.11b half of the scheme. Once a video is selected and begins streaming to the home gateway, the gateway streams the content over the contention free protocol while control information traverses the 802.11b network. The 802.11b network remains largely unloaded by the video and is available for interactive services or other data uses within the home. The internals of the technology are transparent to the consumer and the video is delivered with the same quality as a wired installation.

While existing wireless data networking protocols, with enough modification, can provide some level of Quality of Service to streaming multimedia, a solution that is built from the ground up is needed for widespread use. A contention free scheme is necessary to cut overhead and assure quality of service. As data rates rise, separating network administrative tasks and the delivery of time sensitive media streams is essential in terms of delay and MAC efficiency. The new MAC protocol and network architecture presented above provides a centralized solution for wireless media while incorporating enough legacy technology to be backward-compatible with existing data applications, which may be especially useful in the home.

In summary, the disclosed protocol is based on the following ideas: it is a centralized wireless networking protocol designed for small networks such as a home that uses a separate downlink only channel for the transport of media content, while relying on an auxiliary network for the transport of control and acknowledgment information. The amount of overhead in the high speed downlink channel is minimized in order to maximize throughput and efficiency while minimizing end-to-end delay. Different multimedia flows with different QoS requirements are recognized and provided, with a centralized controller that arbitrates access of different types of calls according to their QoS requirements and a scheduling mechanism that selects packet transmission based on QoS requirements. Mechanism are provided for transmitting data in an asymmetric manner, for providing scalable throughput as a function of physical channel data rate, that supports a mix of traffic including high quality video traffic, voice traffic, audio traffic and data traffic, and a dynamic channel assignment mechanism that switches channels based on channel quality. Finally there is a dual radio transmitter at the wireless gateway: one dedicated to high bandwidth multimedia traffic and the other to low bandwidth control traffic.

Immaterial modifications may be made to the embodiments of the invention described here without departing from the invention.

1. A system for communicating data, the system comprising:
a server station and a client station;
the server station being adapted to connect to the client station by a wireless contention link for exchanging data of a first type between the client station and the server station; and
the server station being adapted to connect to the client station by at least one wireless non-contention link for transmitting data of a second type from the server station to the client station.

2. The system of claim 1 in which the data of the first type has less stringent quality of service requirements than the data of the second type.

3. The system of claim 1 where the data of the first type comprises control data, and the data of the second type comprises multimedia data.

4. The system of claim 1, where the server station comprises a 5 GHz transmitter adapted to transmit data on the non-contention link.

5. The system of claim 1, where the server station comprises a 2.4 GHz transmitter adapted to transmit data on the contention link, and the client station comprises a 2.4 GHz transmitter adapted to transmit data on the contention link.

6. The system of claim 1, where the server station comprises an internal memory device.

7. The system of claim 1, where the server station comprises an external memory device reader.

8. The system of claim 1, where the server station comprises a high-bandwidth connection to an external network.

9. The system of claim 1, where the system comprises a wireless local area network (WLAN).

10. The system of claim 9, where the server station comprises a gateway node of the WLAN, and the client server comprises a node of the WLAN.

11. The system of claim 1, where:
the server station is configured to transmit data packets in a transmission queue on the non-contention channel, and to copy transmitted data packets to an acknowledgement queue;
the client station is configured to transmit the status of received packets on the contention channel; and
the server station is configured to copy data packets that have not been received by the client station from the acknowledgement queue to the transmission queue.

12. A method of transmitting data in a system, the method comprising the steps of:
a server station receiving a request to transmit data to a client station;
the server station transmitting the requested data from the server station to the client station on a wireless non-contention link; and
exchanging control data between the client station and the server station on a wireless contention link to control the transmission of the requested data on the wireless non-contention link.

13. The method of claim 12, where the request to transmit data is initiated by the client station and is transmitted over the wireless contention link.

14. The method of claim 12, where transmitting the requested data comprises transmitting the requested data on a 5 GHz non-contention link.

15. The method of claim 12, where transmitting the control data comprises transmitting the requested data on a 2.4 GHz contention link.

16. The method of claim 12 further comprising the steps of:
the server station copying the requested data as data packets to a transmission queue;
transmitting the data packets in the transmission queue from the server station to the client station;
the server station copying the transmitted data packets into an acknowledgement queue;
transmitting the status of received data packets from the client station to the server station; and
the server station copying unreceived data packets from the acknowledgement queue to the transmission queue.

17. The method of claim 16, where data packets are unreceived by the client server if the data packets are incomplete.

18. The method of claim 16, further comprising the steps of:
assigning the data packets a sequence number,
the client station copying out of sequence data packets to an out of sequence data queue; and
the client station copying sequence numbers that are intermediate received sequence data packets to an unreceived data packet queue.

19. The method of claim 18, where transmitting the status of received data packets comprises transmitting the sequence numbers in the unreceived data packet queue.

20. The method of claim 12 further comprising the steps of:
the server station receiving a plurality of requests for data;
determining the quality of service required for each request, the priority of each request, and the available resources on the non-contention link;
transmitting the requested data using the determined priority of each request on the non-contention link at the required quality of service.

21. The method of claim 20 where determining the priority of each request comprises classifying the request as time-critical, throughput-dependent, or best effort.

22. The method of claim 12, the non-contention link comprising a plurality of channels, the method further comprising the steps of
transmitting data on a channel on the non-contention link:
detecting the quality of service of the channel; and
transmitting data on a different channel on the non-contention link when the quality of service of the original channel drops below a threshold.

23. An enhanced node for a wireless area network (WLAN), the node comprising:
an entry point adapted to intercept data from the WLAN to the node and data from the node to the WLAN;
a demultiplexer adapted to direct the data from the entry point to an application at the node or to a classifier; and
the classifier adapted to classify the data to be transmitted on the WLAN as data to be transmitted on a wireless contention link or as data to be transmitted on a wireless non-contention link.

24. A MAC sublayer comprising a server station sublayer and a client station sublayer:
the server station sublayer comprising:
a transmission queue;
an acknowledgement queue; and
a transmitter, the transmitter adapted to transmit data packets in the transmission queue on a wireless non-contention link and copy the data to the acknowledgement queue; and
the client station sublayer comprising:
an out-of sequence packet queue for storing data packets that are received out of sequence;
an unreceived sequence number list for storing the sequence number of unreceived data packets; and
a timer for transmitting the status of received data packets to the server station sublayer on a wireless contention link.

25. The MAC sublayer of claim 24 the transmitter further comprising a scheduler adapted to determine the strength of a current transmission channel within the non-contention transmission link and to switch to a stronger transmission channels if the strength of the current transmission channel drops below a threshold.
